(19) United States
(12) Patent Application Publication
(10) Pub. No.: US 2008/0018176 A1
(43) Pub. Date: Jan. 24, 2008

(54) Power supply for a rapier head

(75) Inventors: Dietmar Markward, Rueti (CH); Marius Bachofen, Benken (CH); Erich Klaeui, Seuzach (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sultex AG, Rueti (CH)

(21) Appl. No.: 11/801,340

(22) Filed: May 8, 2007

(30) Foreign Application Priority Data
May 26, 2006 (EP) 06405232.7

(51) Int. Cl. H01F 38/14

(52) U.S. Cl. 307/104

(57) ABSTRACT

A power supply for a rapier head (1) of a rapier weaving machine, which is connected to a rapier bar which can be displaced in the longitudinal direction or to a band (2) which can be displaced in the longitudinal direction, is presented. The power supply includes an inductive coupling device with at least one primary induction coil (8) and with at least one secondary induction coil (9) which can be inductively coupled to the primary induction coil, with the secondary induction coil (9) being formed on the rapier bar or on the band (2) respectively.

This application claims the priority of European Patent Application No. 06405232.7, filed May 26, 2006, the disclosure of which is incorporated herein by reference.

The invention relates to a power supply for a rapier head of a rapier weaving machine in accordance with the preamble of claim 1 and to a method for supplying power to a rapier head in a rapier weaving machine in accordance with the preamble of claim 8, as well as to a weaving machine with a power supply of this kind and for carrying out a method of this kind.

In rapier weaving machines the weft thread is inserted into a shed by means of an inserting rapier which is mounted on a bar or on a flexible band, and is taken over at a transfer point in the central part of the shed by a receiving rapier and transported further. The inserting rapier has the task of reliably gripping the presented weft thread, of inserting the latter into the shed and of guiding it precisely to the receiving rapier. Each rapier includes a rapier head with a thread clamp in order to firmly clamp the weft thread during the weft insertion. In the case of automatically clamping thread clamps the thread takeover takes place through drawing in or out respectively of the weft thread from previously set clamping regions of the respective thread clamps. For the manufacture of cloths with weft yarns of different thicknesses or with yarns of different smoothness, controlled thread clamps can be used in one or both rapier heads, with the thread clamp of the inserting rapier being actively opened or that of the receiving rapier actively closed during the thread transfer.

The controlled thread clamps can be controlled mechanically and/or electrically. An electrically controlled thread clamp with an electrical actuator is for example described in the specification WO 99/60193. The supplying of the controlled thread clamp with power takes place via an induction coil which is arranged in the rapier head and which is coupled inductively to a second induction coil which is arranged above the shed. The energy transfer between the two induction coils described in WO 99/60193 is not very efficient, since both induction coils are constructed as air coils and the distance between the coils is relatively large. In addition, the transferred power is limited as a result of the interference radiation which is radiated from the induction coils, since maximum legally prescribed limiting values for them must be observed.

The object of the invention is to make available a power supply for a rapier head of a rapier weaving machine and a method for supplying power to a rapier head in a rapier weaving machine which enable a greater transfer of power in comparison with the above described prior art and by means of which an arrangement of an induction coil above or below the shed can be avoided.

This object is satisfied in accordance with the invention by the power supply which is defined in claim 1 and by the method for supplying power to a rapier head in a rapier weaving machine which is defined in claim 8 as well as by the rapier weaving machine which is defined in claim 10.

The power supply in accordance with the invention for a rapier head of a rapier weaving machine which is connected to a rapier bar which can be displaced in the longitudinal direction or to a band which can be displaced in the longitudinal direction includes an inductive coupling device with at least one primary induction coil and with at least one secondary induction coil which can be inductively coupled to the primary induction coil. The power supply is characterized in that the secondary induction coil is formed on the rapier bar or on the band respectively and/or on an elongate mounting part of the rapier head. The primary induction coil is preferably stationary.

In an advantageous embodiment the secondary induction coil is formed to be elongate so that it extends for example over a length of at least 5 cm, 15 cm or at least 50 cm. In a further advantageous embodiment the secondary induction coil includes one or more current loops or windings which can form a single magnetic pole or a plurality of magnetic poles following one another in succession.

In an advantageous variant the secondary induction coil is connected to an energy store, for example to a condenser or to an accumulator, via a converter.

In a further advantageous embodiment the inductive coupling device includes at least one magnetisable core and/or a magnetisable yoke. In this arrangement the primary induction coil can e.g. be arranged on a magnetisable core which has an air gap into which the secondary induction coil can be introduced.

Furthermore, the invention includes a method for supplying power to a rapier head in a rapier weaving machine which is connected to a rapier bar or to a band. In said method at least one primary induction coil of an inductive coupling device is coupled to at least one secondary induction coil of the same and energy is transferred from the primary induction coil to the secondary induction coil, with the secondary induction coil respectively extending over a portion of the rapier bar or of the band and/or of an elongate mounting part of the rapier head.

In an advantageous embodiment of the method a field is produced by the primary induction coil, for example using a magnetisable core, with it being possible for the magnetic circuit e.g. to extend in the magnetisable core with the exception of one or more air gaps, and with the secondary induction coil being respectively led together with the rapier bar or the band or the mounting part through the field which is produced by the primary induction coil.

Furthermore, the invention includes a rapier weaving machine with a power supply in accordance with one of the above described embodiments and/or equipped for carrying out a method in accordance with the above description.

Thanks to the arrangement of the secondary induction coil at the rapier bar or at the band and/or at the mounting part, the power supply in accordance with the invention and the method for supplying power to a rapier head in a rapier weaving machine have the advantage that the clamping apparatus can be supplied with current and/or control information during a part of or during the entire weft insertion, depending on the length of the secondary induction coil. In addition the range of the field of the inductive coupling device can be greatly restricted by means of a magnetisable core, through which the power which is transferred by the coupling device can be increased. A further advantage is the fact that the primary induction coil can be mounted outside of and laterally of the shed. Depending on the application and, in particular, when the energy which is transferred by the inductive coupling device is to be stored in the rapier head, it is sufficient to restrict the length of the secondary induction coil to a portion of the length of the rapier bar or of the band and/or of the mounting part.

The above description of embodiments serves merely as an example. Further advantageous embodiments result from the subordinate claims and the drawings. Moreover, in the context of the present invention individual features from the described or illustrated embodiments and variants can also be combined with one another in order to form new embodiments.

The invention will be explained in the following in more detail with reference to the exemplary embodiment and with reference to the drawings. Shown are:

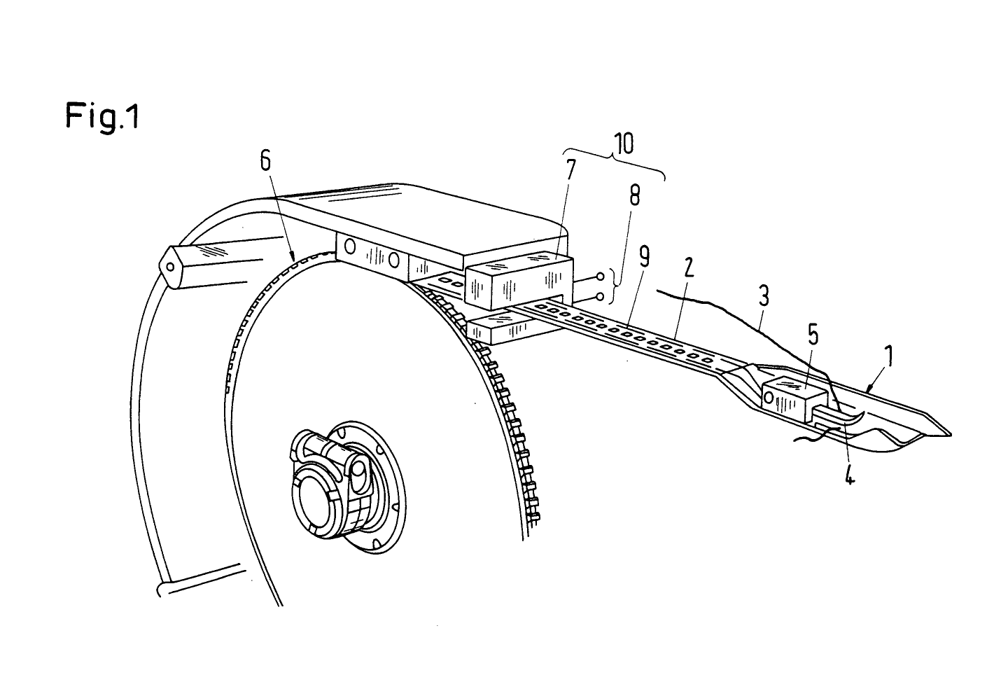

FIG. 1 a schematic illustration of a rapier head and of a band drive with an exemplary embodiment of a power supply for the rapier head in accordance with the present invention, in a perspective view,

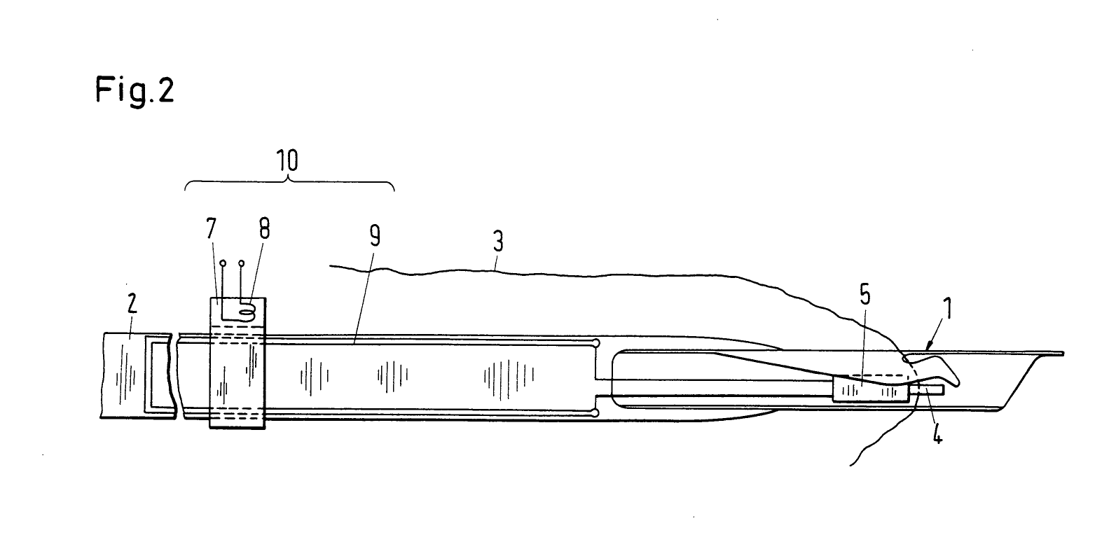

FIG. 2 a second exemplary embodiment of a power supply for a rapier head in accordance with the present invention seen from above, which is constructed analogously to the exemplary embodiment of FIG. 1,

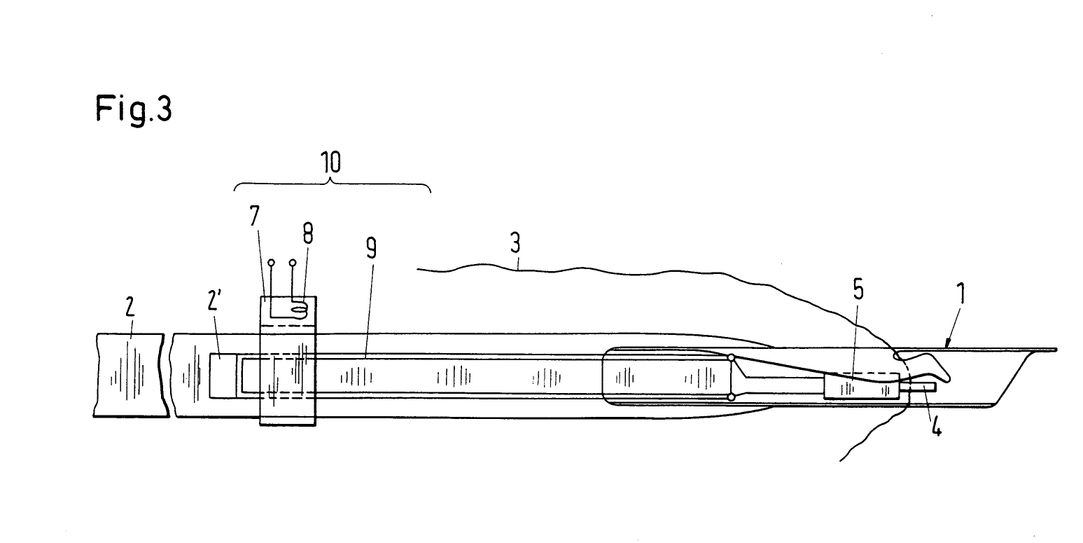

FIG. 3 a third exemplary embodiment of a power supply for a rapier head in accordance with the present invention with an elongate mounting part, and

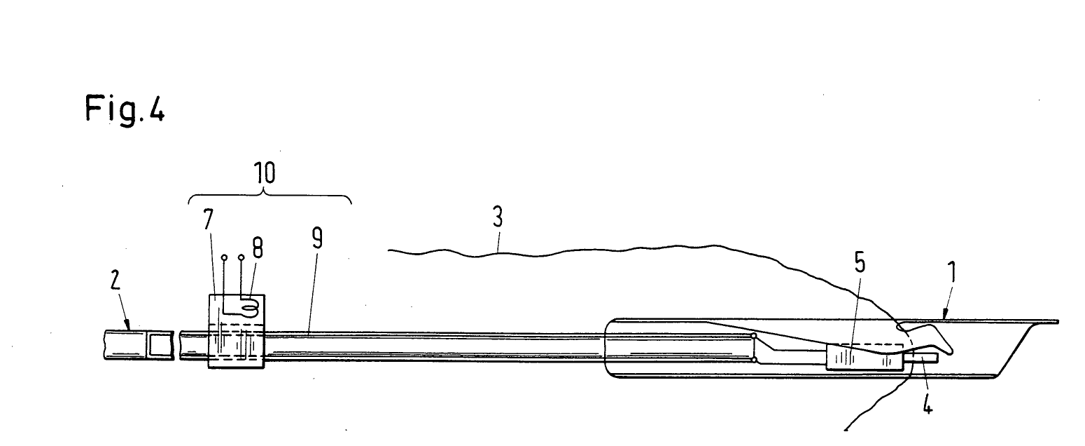

FIG. 4 a fourth exemplary embodiment of a power supply for a rapier head in accordance with the present invention with a rapier bar.

FIG. 1 shows a schematic illustration of a rapier head 1 and of a band drive with an exemplary embodiment of a power supply 10 for the rapier head in accordance with the present invention. The rapier head 1 is connected to a band 2 which is displaceable in the longitudinal direction and which can be moved forwards and backwards by a band drive 6. The band drive 6 includes for example, as shown in FIG. 1, a drive wheel which is provided with teeth at its periphery which engage cut-outs of the band 2. The band guides for guiding the band 2 in the longitudinal direction have been omitted from FIG. 1 for the sake of clarity. In the event that the band is designed to be flexible, it can be led around the drive wheel, as shown in FIG. 1.

In this exemplary embodiment the power supply 10 for the rapier head includes an inductive coupling device with at least one primary induction coil 8, which is arranged to be stationary in an advantageous variant, and with at least one secondary induction coil 9 which is inductively coupled to the primary induction coil. During operation the primary induction coil 8 is advantageously supplied with power by a generator, which operates for example at a frequency of from 5 kHz to 100 kHz. The inductive coupling device can, as shown in FIG. 1, additionally include a magnetisable core 7 which consists for example of transformer metal sheet or ferrite, and which e.g. has a slot through which the band 2 is led. The secondary induction coil 9 is formed on the band 2, for example in that one or more elongate conductor loops are embedded into the band or are applied to the band, for example through the laminating on of a copper foil. In a further advantageous variant the secondary induction coil 9 extends over a length of at least 5 cm, 15 cm or at least 50 cm.

In a particularly advantageous variant the secondary induction coil 9 is made so long that it does not leave the field of the primary induction coil 8 during the forwards and backwards movement of the band 2, i.e. so that the rapier head can be supplied with current during the entire weft insertion and/or weaving machine cycle without intermediate store. In this case it is also possible to transfer information to the rapier head via the inductive coupling device during the entire weft insertion and/or weaving machine cycle, for example information for the control of a thread clamp which is arranged in the rapier head. The information can for example be modulated onto the current flow which serves for the power supply or transferred by means of special control pulses.

The rapier head 1 advantageously includes a controlled thread clamp with a clamping part 4 for firmly holding a weft thread 3 and an actuator 5 which is electrically connected to the secondary induction coil 9 and by means of which the clamping part 4 can be pressed against a support or a pressed on clamping part can be released. The connection of the actuator 5 to the secondary induction coil 9 can take place directly or via a converter, which can for example contain a demodulator and/or amplifier.

In an advantageous embodiment the secondary induction coil 9 is connected via a converter to a non-illustrated energy store, for example to an accumulator or a condenser, which intermittently or permanently supplies the actuator with current. The secondary induction coil can be made shorter in this case, in particular shorter than the path traveled by the rapier head, since interruptions of the power supply via the inductive coupling device can be bridged by the energy store. Information can be transmitted e.g. optically or by means of high frequencies to the rapier head while the power supply via the inductive coupling device is interrupted, or also generally, with it being possible for the secondary induction coil in the latter case to be used as an antenna. Moreover, the thread clamp in the rapier head can also be controlled via a sensor, such as e.g. a proximity sensor, which is arranged in the rapier head.

FIG. 2 shows a second exemplary embodiment of a power supply for a rapier head 1 in accordance with the present invention as seen from above, which is constructed analogously to the first exemplary embodiment in FIG. 1. The rapier head 1 is connected to a band 2 which can be displaced in the longitudinal direction and which can be moved forwards and backwards by a non-illustrated band drive. In the second exemplary embodiment the power supply 10 for the rapier head includes an inductive coupling device with at least one primary induction coil 8 and with at least one secondary induction coil 9, which is coupled inductively to the primary induction coil. The inductive coupling device can, as shown in FIG. 2, additionally include a magnetisable core 7, which e.g. has a slot through which the band 2 is led. The secondary induction coil 9 is formed on the band 2, for example in that an elongate conductor loop is embedded into the band or is applied onto the band. Where required a plurality of conductor loops or windings and/or a plurality of secondary induction coils can be formed on the band 2.

In an advantageous variant the secondary induction coil 9 extends over a length of at least 5 cm, 15 cm or at least 50 cm. In a particularly advantageous variant the secondary induction coil 9 is made so long that it does not leave the field of the primary induction coil 8 during the forward and backward movement of the band 2, i.e. the energy and/or information transfer via the inductive coupling device is possible during the entire weft insertion and/or weaving machine cycle.

Further variants and details for the design of the power supply which is shown in FIG. 2 can be found in the description of FIG. 1.

FIG. 3 shows a third variant of a power supply for a rapier head 1 in accordance with the present invention. The exemplary embodiment which is shown in FIG. 3 differs from that shown in FIG. 2 through an elongate mounting part 2′ by means of which the rapier head is secured to the band 2. Usually the mounting part 2′ contains a section, which can for example be designed to be flat and to extend over a length which is greater than the length of the rapier head 1 when required. In this way a reliable securing of the rapier head to the band 2 can be achieved even when the latter is flexible and comparatively thin. The mounting part is expediently arranged on the band over at least a portion of its length.

In the third variant the power supply 10 for the rapier head includes an inductive coupling device with at least one primary induction coil 8 and with at least one secondary induction coil 9 which is inductively coupled to the primary induction coil. The inductive coupling device can, as shown in FIG. 3, additionally include a magnetisable core 7, which has e.g. a slot or an aperture through which the band 2 and/or the mounting part 2′ is led. The secondary induction coil 9 in the third exemplary embodiment is secured to the mounting part 2′ in that for example one or more elongate current loops are applied to the mounting part 2′. In an advantageous variant the mounting part 2′ contains a magnetisable material, along which the current loop or loops are arranged.

Further variants and details for the design of the power supply which is shown in FIG. 3 can be found in the descriptions of FIGS. 1 and 2.

FIG. 4 shows a fourth exemplary embodiment of a power supply for a rapier head 1 in accordance with the present invention, with a rapier bar 2 which can be displaced in the longitudinal direction and to which the rapier head is connected. In the fourth variant the power supply 10 for the rapier head includes an inductive coupling device with at least one primary induction coil 8 and with at least one secondary induction coil 9 which is inductively coupled to the primary induction coil. The inductive coupling device can, as shown in FIG. 4, also include a magnetisable core 7 which has e.g. a slot or an aperture which is matched to the profile of the rapier bar and through which the rapier bar 2 is led. The secondary induction coil 9 is formed on the rapier bar 2, for example in that one or more elongate current loops are embedded into the rapier bar or are applied to the rapier bar. In an advantageous variant the rapier bar 2 contains a magnetisable material, for example a tube or section or metal sheet of e.g. magnetisable steel, along which the current loop or loops are arranged.

Further variants and details for the design of the power supply which is shown in FIG. 4 can be found in the descriptions of FIGS. 1, 2 or 3.

An exemplary embodiment of the method in accordance with the invention for supplying a rapier head 1 in a rapier weaving machine with power, in which the rapier head is connected to a rapier bar which is displaceable in the longitudinal direction or to a band 2 which is displaceable in the longitudinal direction, will be described in the following with reference to FIGS. 1 and 2. In this method at least one primary induction coil 8 of an inductive coupling device is coupled to at least one secondary induction coil 9 of the same and energy is transferred from the primary induction coil to the secondary induction coil, with the secondary induction coil 9 extending over a portion of the rapier bar or of the band 2 and/or of an elongate mounting part 2′ of the rapier head 1.

In an advantageous embodiment of the method a field is produced by the primary induction coil 8, advantageously using a magnetisable core 7, and the secondary induction coil 9 together with the rapier bar or the band 2 or the mounting part 2′ respectively is moved through the field which is produced by the primary induction coil. For the production of the field the primary induction coil 8 can for example be supplied with current by means of a generator, which e.g. operates at a frequency of from 5 kHz to 100 kHz.

It is advantageous that the primary induction coil can be provided outside of and laterally of the shed in the power supply in accordance with the invention for a rapier head and in the method in accordance with the invention. Through this the spatial distance between the primary and secondary induction coil can be kept small and the transferred power can be increased. An additional increase in the transferred power results when a magnetisable core 7 is used in the inductive coupling device. A further advantage is that the length of the secondary induction coil can be chosen within a broad range, through which the energy transfer via the inductive coupling device can be ensured during a portion of or during the entire weft insertion as required.

1. A power supply for a rapier head (1) of a rapier weaving machine, which is connected to a rapier bar which can be displaced in the longitudinal direction or to a band (2) which can be displaced in the longitudinal direction, said power supply (10) including an inductive coupling device with at least one primary induction coil (8) and with at least one secondary induction coil (9) which can be inductively coupled to the primary induction coil, characterized in that the secondary induction coil (9) is formed at the rapier bar or at the band (2) respectively and/or at an elongate mounting part (2′) of the rapier head.

2. A power supply in accordance with claim 1, with the primary induction coil (8) being stationary.

3. A power supply in accordance with claim 1, with the secondary induction coil (9) being elongate, in particular in such a manner that the secondary induction coil extends over a length of at least 5 cm, at least 15 cm or at least 50 cm.

4. A power supply in accordance with claim 1, with the secondary induction coil (9) including one or more current loops.

5. A power supply in accordance with claim 1, with the secondary induction coil (9) being connected to an energy store via a converter.

6. A power supply in accordance with claim 1, with the inductive coupling device including at least one magnetisable core (7) and/or a magnetisable yoke.

7. A power supply in accordance with claim 6, with the primary induction coil (8) being arranged on a magnetisable core (7) which has an air gap into which the secondary induction coil (9) can be introduced.

8. A method for supplying power to a rapier head (1) in a rapier weaving machine, which is connected to a rapier bar or to a band (2), wherein at least one primary induction coil (8) of an inductive coupling device is coupled to at least one secondary induction coil (9) of the same and energy is transferred from the primary induction coil to the secondary induction coil, characterized in that the secondary induction coil (9) extends over a portion of the rapier bar or of the band (2) respectively and/or of an elongate mounting part (2′) of the rapier head (1).

9. A method in accordance with claim 8, with a field being produced by the primary induction coil (8), in particular through the use of a magnetisable core (7), and with the secondary induction coil (9) being respectively led together with the rapier bar or the band (2) or the mounting part (2′) through the field which is produced by the primary induction coil.

10. A rapier weaving machine including a power supply in accordance with claim 1.

11. A rapier weaving machine including a power supply equipped for carrying out a method in accordance with claim 8.
